(19) United States
(12) Patent Application Publication
(10) Pub. No.: US 2006/0040399 A1
(43) Pub. Date: Feb. 23, 2006

(54) Process for controlling hydrogen partial pressure in single and multiple hydroprocessors

(76) Inventor: William F. Hurt, Luling, LA (US)

Correspondence Address: William F. Hurt, #3 Patricia Ct., Luling, LA, 70070, US

(21) Appl. No.: 10/922,688

(22) Filed: Aug. 21, 2004

(51) Int. Cl. C10G 45/00; G05D 11/00

(52) U.S. Cl. 436/55; 208/209; 208/213; 208/108; 422/62

(57) ABSTRACT

A control scheme for controlling hydrogen partial pressure is provided that generally comprises a hydrogen purity analyzer that measures hydrogen purity on one or more hydroprocessing units. The hydrogen analyzer measures the purity of the treat gas, which is converted into a control signal and is transmitted to the appropriate hydroprocessing unit's purge gas controller. As hydrogen purity decreases in the hydroprocessing unit's recycle stream, the purge gas control valve opens and purges cracked gas contaminants. As hydrogen purity fluctuates, the purge gas control valve will open and close to maintain the desired purity setpoint. A programmable logic controller manages the inputs from the one or more hydroprocessing units and the signals that are transmitted to each unit's purge controller. The programmable logic controller may also be utilized to reactor hydrogen quench systems. The control of hydrogen partial pressure improves catalyst activity, hydrogen usage, and fuel efficiency.

### STATEMENT REGARDING FEDERALLY SPONSORED RESEARCH OR DEVELOPMENT

Not Applicable

### FIELD OF THE INVENTION

The present invention relates to the operation and control of petroleum hydroprocessing units such as, hydrotreaters, hydrocrackers, and the like. More specifically, the present invention relates to the control of hydrogen partial pressure in these units.

### BACKGROUND OF THE INVENTION

In a hydrotreating or hydrocracking process, sulfur is removed from gasoils and distillate oils. Typical gasoil feedstocks to hydroprocessing units include heavy vacuum gas oil (HVGO), light vacuum gas oil (LVGO) and heavy coker gas oil (HCO). Typical distillate feed stocks include virgin diesel, fluid catalytic cracker (FCC) light cycle oil (LCO), light coker distillate (LCD) and heavy coker distillate (HCD).

The feed to a typical hydroprocessing unit is pumped through a reactor where sulfur-containing compounds react with hydrogen to produce hydrogen sulfide (H₂S), thereby liberating the sulfur from the feed. The resulting mixture of processed oil and hydrogen sulfide vapor is separated in a downstream vessel, referred to as a high pressure separator.

The reaction of hydrogen with the sulfur-containing compounds in the feed is catalytically driven. One of the primary operating variables that impacts catalyst activity is hydrogen partial pressure, which is defined as the amount of hydrogen pressure in the inlet vapor space of the hydroprocessing reactor. Hydrogen partial pressure is directly proportional to the amount of hydrogen in the reactor inlet as well as total pressure. In order to sufficiently promote the desired reactions, an excess amount of hydrogen is supplied to the reactor inlet. Therefore, unreacted hydrogen also exits the reactor along with the processed oil and hydrogen sulfide vapor.

In addition to the desulfurization reaction described above, other reactions also occur within the reactor, such as olefin, aromatic, and polynuclear aromatic saturation reactions and cracking reactions. The cracking reactions produce light end hydrocarbons that contaminate the unreacted hydrogen exiting the reactor.

The rector effluent is phase separated to recover the unreacted hydrogen. The vapor phase, which contains the hydrogen, hydrogen sulfide and light end hydrocarbons is scrubbed to remove the hydrogen sulfide and recycled back to the reactor inlet. Since some of the hydrogen was consumed in the reactor, make-up hydrogen must be added to increase the hydrogen concentration of the recycled gas. The combination of recycled hydrogen and make-up hydrogen is commonly referred to as treat gas hydrogen. The treat gas is pressured up to reactor operating pressure via a compressor, which is commonly referred to as the recycle compressor. The recycle compressor discharge pressure maintains the pressure at the reactor inlet and is typically controlled by either throttling the compressor suction pressure or by cascading the compressor discharge pressure to a purge controller that reduces the recycle hydrogen flow rate by purging recycle hydrogen to an alternate location, such as a plant fuel gas system.

Conventional control systems for maintaining hydrogen purity in hydroprocessing units typically consist of a control loop having either two or three controllers. In the two controller scheme, one controller controls the makeup flow of fresh hydrogen into the units hydrogen recycle (treat gas) loop. The other control valve controls the compressor's discharge pressure via modulating the input of the high pressure separator off gas into the recycle loop. As the discharge pressure oversteps its maximum targeted pressure, the control valve will open and allow heavy gas to be purged, typically to the plant's fuel header. The compressor's discharge pressure must be controlled to ensure that the maximum equipment pressure limitations are not exceeded downstream of the compressor.

In the three controller scheme, one controller, a flow controller, controls the hydrogen makeup flow on a flow measurement setpoint. The operator resets the fresh hydrogen flow as hydrogen supplies dictate. The second controller controls the compressor discharge pressure via a throttling valve on the compressor's suction line. As discharge pressure rises and falls, the control valve opens and closes, thereby controlling the compressor's discharge pressure. The third controller modulates the purge gas (also referred to as bleed gas) flow on a flow measurement setpoint. The operator sets the purge gas flow target setpoint and as flow varies, the flow indicator will transmit a signal to the control valve which will open and close the valve, depending on how the actual flow measurement compares to the targeted setpoint.

These types of control schemes involve setting and resetting the purge gas flow control target setpoint manually based upon on analytical lab data. In other words, as lab analyses of the recycle gas are taken (normally once per 12 hour shift), the operator adjusts purge gas flow based on these analyses. As hydrogen purity declines, the operator opens the purge gas flow controller and bleeds light end hydrocarbon contaminants out of the system. These types of manual control schemes have inherent disadvantages that are mitigated by the present invention.

### SUMMARY OF THE INVENTION

As stated above, the present invention relates to the control of hydrogen partial pressure at the reactor inlet, which is improved and automatically controlled over time. Conventional control schemes do not take into account the importance and significance of control. Some conventional processes place emphasis on absorption of contaminants utilizing a sponge oil instead of actually controlling hydrogen partial pressure. While this method can be effective, the capital that is required is much more significant than what is proposed. By utilizing the control scheme of the present invention, the average hydrogen purity may be improved by about 10-15% over conventional control schemes. This increase in hydrogen partial pressure provides longer catalyst life, inhibits coke formation, allows for the processing of heavier feedstocks, provides higher product yields, improves product quality, and results in a measurable energy savings.

Accordingly, a control scheme for controlling hydrogen partial pressure is provided that generally comprises a hydrogen purity analyzer that measures hydrogen purity on one or more hydroprocessing units. The hydrogen analyzer measures the purity of the treat gas, which is converted into a control signal and is transmitted to the appropriate hydroprocessing unit's purge gas controller. As hydrogen purity decreases in the hydroprocessing unit's recycle stream, the purge gas control valve opens and purges cracked gas contaminants. As hydrogen purity fluctuates, the purge gas control valve will open and close to maintain the desired purity setpoint. A programmable logic controller (PLC) and/or a programmable electronic system manages the inputs from the one or more hydroprocessing units and the signals that are transmitted to each unit's purge controller. The programmable logic controller may also be utilized to control reactor hydrogen quench systems.

### BRIEF DESCRIPTION OF THE DRAWINGS

FIG. 1 illustrates the process control scheme of the present invention for a single hydroprocessing unit.

FIG. 2 illustrates the process control scheme of the present invention for multiple hydroprocessing units.

### PREFERRED EMBODIMENTS OF THE INVENTION

In the following detailed description of the preferred embodiments, reference is made to the accompanying drawings, which form a part hereof, and in which are shown by way of illustration specific embodiments in which the invention may be practiced. It is to be understood that other embodiments may be utilized and structural changes may be made without departing from the scope of the present invention.

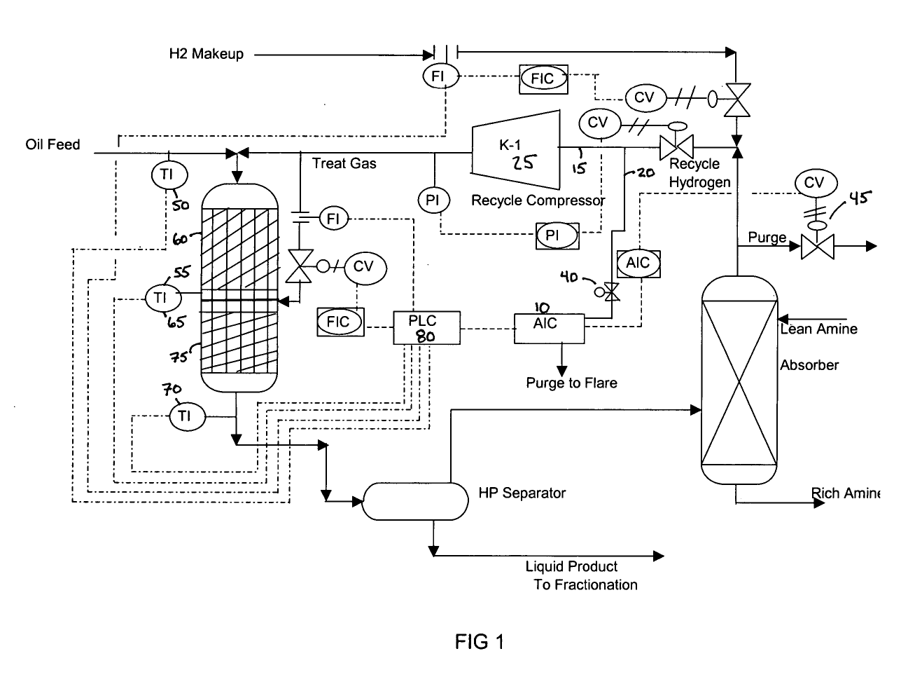

In the single unit hydrogen partial pressure control scheme, as shown in FIG. 1, a hydrogen analyzer 10 receives a sample from the hydroprocessing unit's recycle stream 15 upstream of compressor 25. A sample is drawn continuously through a small sampling line 20 (¾″ SS tubing) and the sample passes through the analyzer 10 and discharges to the plant flare system. A sampling pressure letdown valve 40 is located in the sample line 20 to reduce the pressure on the hydrogen analyzer 10.

Hydrogen purity is measured and converted into a 4 to 20 milliamp (mA) signal. The signal is transmitted to PLC 80, which calculates hydrogen partial pressure based upon the hydrogen purity and the reactor total pressure. PLC 80 transmits a 4 to 20 mA signal corresponding the hydrogen partial pressure to a controller that actuates purge valve 45. The electronic signal may also be converted to a pneumatic signal and transmitted to a pneumatic controller. As hydrogen partial pressure decreases, the signal will decrease, which will transmit into higher air pressure which will pneumatically force the valve 45 to open more than the previous signal. As the valve 45 opens, more cracked gas contaminants are released to fuel and hydrogen partial pressure increases.

Hydrogen quench control may also be provided to maintain consistent hydrogen partial pressures throughout a multiple bed reactor. Inlet temperature 50 and outlet temperature 55 for reactor bed 60 and inlet temperature 65 and outlet temperature 70 for reactor bed 75 are transmitted to programmable logic controller (PLC) 80. The PLC logic is programmed to take these temperatures and determine the delta temperature across each catalyst bed and the overall reactor delta temperature.

PLC 80 calculates the hydroprocessing unit's hydrogen consumption. This calculation is determined via a hydrogen mass balance across the unit. Hydrogen consumption is calculated from the hydrogen purity in the corrected treat gas flow minus the hydrogen purity in the offgas flows, with an estimate for hydrogen solution losses. In a two bed reactor, the percentage of delta temperature across the first bed is determined in regard to total delta temperature across the reactor's two beds. Hydrogen consumption is then multiplied by this percentage and PLC 80 calculates hydrogen consumption across the reactor's first bed. PLC 80 will then adjust the hydrogen quench flow at the outlet of reactor bed 60 to match the hydrogen consumption across the first bed. Improvements and increases in hydrogen partial pressure at the inlet to catalyst bed 75 will improve overall desulfurization efficiency and reduce coke laydown rates within catalyst bed 75. Additionally, multivariable model control can be integrated into this control scheme to adjust H2 makeup flow control rates. As hydrogen consumption fluctuates, the multivariable model system works with the PLC to adjust the fresh hydrogen makeup flow set point and rate.

In multiple unit control, one hydrogen analyzer is utilized to control multiple purge gas streams flows on two or more units. This option will be more attractive to the small refiner who has small cash reserves for capital investments.

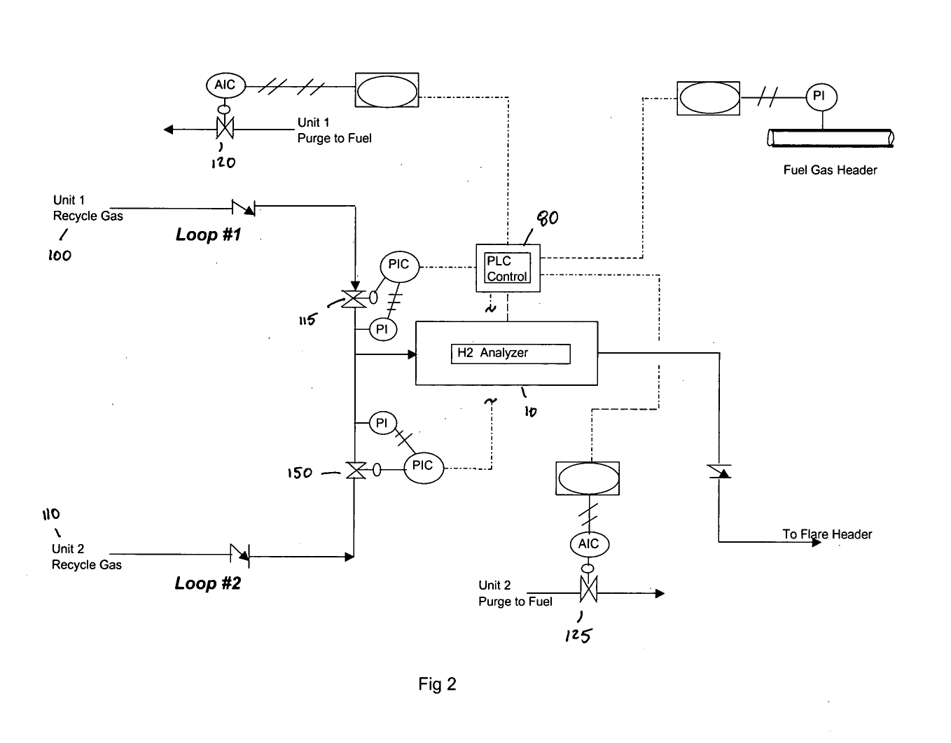

For the purpose of example and as illustrated in FIG. 2, one analyzer 10 is configured to receive two inputs from two separate recycle streams 100, 110 from two separate hydroprocessing units. In this control scheme, a programmable logic controller (PLC) 80 manages the sequencing of sampling inputs and transmission outputs. The PLC 80 controls when each sample is taken from which unit, the purge that is required to clear the sample line of the previous unit's sample, and the transmission of output signals to each unit's purge gas controller. The control sequence is provided below:

Process Operation

1. Valve 115 on loop 1 opens while valve 150 on loop 2 remains closed.
2. Analyzer 10 receives sample from loop 1 and purges a continuous flow of the sampled stream to the flare for 30 seconds. Analyzer 10 then transmits the hydrogen purity measurement to PLC 80.
3. PLC 80 calculates hydrogen partial pressure based upon reactor total pressure and compares the hydrogen partial pressure to a desired setpoint. If calculated hydrogen partial pressure is less than the setpoint, purge valve 120 opens resulting in an increase in hydrogen partial pressure.
4. After a pre-determined amount of operational time, which depends on the number of units being controlled, PLC 80 shuts valve 115. Purge valve 120 maintains its position.
5. PLC 80 opens valve 150 on loop 2 and purges sample to flare for 30 seconds.
6. Loop two recycle gas is analyzed and signal is transmitted to PLC 80 for calculation of hydrogen partial pressure.
7. Similar to step 3, PLC causes actuation of purge valve 125 if hydrogen partial pressure is less than the desired setpoint.
8. After a pre-determined amount of operational time, PLC 80 shuts valve 150, maintains the position of purge valve 125 and begins to process again at step 1.

As with the single unit control scheme, the PLC 80 may also control hydrogen quench flows for multiple bed reactors in both hydroprocessing units.

The increase in the average hydrogen partial pressure that is obtained from the disclosed control scheme results in an increase in catalyst life. Catalyst cycle life is defined by the delta temperature between SOR, start of run reactor conditions, EOR, end of run reactor conditions, and catalyst deactivation rate. SOR conditions are determined by catalyst activity, unit pressure, and feed quality. EOR temperature is typically defined by a metallurgical limit in the unit or by a product quality constraint (eg; in diesel hydrotreating units, diesel product color quality will degrade above temperatures of 720 F). More specifically, maintaining and sustaining an increase in average hydrogen partial pressure yields a reduction in catalyst deactivation rate, which corresponds to longer catalyst life. For a typical gas oil hydrotreater (operating at 900 psig), the catalyst deactivation rate can be reduced 0.5 degrees Fahrenheit per month. This equates to a reduction in catalyst deactivation of 10% per month, which corresponds to approximately 3.6 to 4 months of additional catalyst life on a unit operating on a 36 month cycle life. SOR temperature can be reduced by 5-7 degrees Fahrenheit, which on a unit with a 5 degrees Fahrenheit/month deactivation rate, this equates to an additional 1 month in catalyst life. In total, catalyst deactivation rate will be reduced and the net improvement in catalyst activity is 24 degrees Fahrenheit over the cycle life of the catalyst.

In hydroprocessing reactors, coke is formed from the reaction of polynuclear aromatic compounds with hydrogen. Polynuclear aromatics (PNAs) are long-chained aromatic compounds that when allowed to be saturated with hydrogen will form long chained asphaltene “like” molecules. Higher hydrogen partial pressure drives reaction rates away from the saturation of PNAs towards more attractive desulfurization reactions. More specifically, maintaining and sustaining an increase in average hydrogen partial pressure yields the following benefits regarding coke formation: non-saturation of PNA compounds, directionally, will reduce reactor heat requirements and drive reaction rates towards beneficial desulfurization and dentrification reactions; and non-saturation of PNA compounds will produce less coke. From an operational standpoint, this benefit is significant to the refiner in that during the reactor run, coke compounds will harden as more and more heat is applied to the catalyst to compensate for losses of catalyst active sites. After the reactor run has been completed and the reactor has been taken out of service for the specific purpose of replacing catalyst, significant delays in maintenance turnaround time will be incurred due to an intensive drilling process required to remove pockets of hardened coke in the catalyst bed.

Increasing and sustaining a higher average hydrogen partial pressure enhances a hydroprocessing unit's capability to run heavier feed. In the case of a gas oil hydrotreater where the feed blend is limited to 50% HVGO and 50% LVGO under prior art conditions, the percentage of HVGO could be increased (nominally) to 60%. In summary, the increase in higher hydrogen partial pressure would allow the refiner to increase the concentration of “heavier” feed at similar unit conditions (ie; charge rate would not change, reactor temperature would not change).

Overall unit yield (stripper bottoms/feed) can also increase due to an increase in hydrogen partial pressure. Olefinic saturation will increase as a result of increased hydrogen availability and fewer cracking reactions will take place (as a result of increased hydrogen partial pressure, less reactor temperature will be required). As a result, overall distillate production will increase.

An increase in hydrogen partial pressure will also improve jet and diesel fuel quality. Cetane number can improve by about 1-2 numbers, and aniline point will improve by about 5-10 F.

For a gas oil hydrotreater unit processing 25,000 BPD, a reduction in reactor temperature of 24 degrees Fahrenheit over a three year run, could conserve up to 121 billion BTUs over a three year catalyst run. This corresponds to a significant energy savings.

Although the present invention has been described in terms of specific embodiments, it is anticipated that alterations and modifications thereof will no doubt become apparent to those skilled in the art. It is therefore intended that the following claims be interpreted as covering all alterations and modifications that fall within the true spirit and scope of the invention.

What is claimed is:

1. A process control apparatus for controlling hydrogen partial pressure in a hydroprocessing reactor having an oil feed and a treat gas feed, the process control apparatus comprising:
a hydrogen analyzer for measuring the hydrogen purity of the treat gas supplied to the reactor, wherein the treat gas feed is composed of the mixture of a make-up hydrogen supply and recycled hydrogen from the reactor;
a pressure sensor for measuring the operating pressure of the reactor;
a programmable logic controller and/or a programmable electronic system coupled to the pressure sensor and the hydrogen analyzer that receives the measurement of the hydrogen purity from the hydrogen analyzer and the measurement of the operating pressure of the reactor from the pressure sensor and calculates the hydrogen partial pressure of the treat gas feed;
a purge control valve that diverts a portion of the recycle hydrogen from the treat gas feed, the purge control valve having a hydrogen partial pressure setpoint and under control of the programmable logic controller, which actuates the purge control valve in response to the deviation of the calculated hydrogen partial pressure from the hydrogen partial pressure setpoint.

2. The process control apparatus of claim 1, further comprising
a plurality of catalyst beds within the reactor and a plurality of treat gas feed lines that supply treat gas to the inlet of each of the plurality of catalyst beds;
an inlet temperature sensor and an outlet temperature sensor for measuring the temperature at the inlet and outlet of each of the plurality of catalyst beds, the temperature sensors coupled to the programmable logic controller, which calculates hydrogen consumption across each of the plurality of catalyst beds based upon the inlet and outlet temperature difference;
and flow control valves on each of the plurality of treat gas feed lines, each having a flow setpoint and under control of the programmable logic controller, which actuates the flow control valves in response to the calculated hydrogen consumption across each of the plurality of catalyst beds.

3. A process control apparatus for controlling hydrogen partial pressure in a plurality of hydroprocessing reactors, each having an oil feed and a treat gas feed, the process control apparatus comprising:
a hydrogen analyzer for measuring the hydrogen purity of the treat gas supplied to each reactor, wherein the treat gas feed to each reactor is composed of the mixture of a make-up hydrogen supply and recycled hydrogen from each respective reactor;
a plurality of pressure sensors for measuring the operating pressure of each reactor;
a programmable logic controller coupled to the plurality of pressure sensors and the hydrogen analyzer that receives the measurement of the hydrogen purity from the hydrogen analyzer and the measurements of the operating pressure of each reactor from the plurality of pressure sensors and calculates the hydrogen partial pressure of the treat gas feed to each reactor;
a plurality of purge control valves that diverts a portion of the recycle hydrogen from each reactor from the treat gas feed to each reactor, the plurality of purge control valves each having a hydrogen partial pressure setpoint and under control of the programmable logic controller, which actuates the plurality of purge control valves in response to the deviation of the calculated hydrogen partial pressure for each reactor from the hydrogen partial pressure setpoint for each of the plurality of purge control valves.

4. The process control apparatus of claim 3, further comprising
a plurality of catalyst beds within each of the plurality of reactors and a plurality of treat gas feed lines that supply treat gas to the inlet of each of the plurality of catalyst beds;
an inlet temperature sensor and an outlet temperature sensor for measuring the temperature at the inlet and outlet of each of the plurality of catalyst beds, the temperature sensors coupled to the programmable logic controller, which calculates hydrogen consumption across each of the plurality of catalyst beds based upon the inlet and outlet temperature difference;
and flow control valves on each of the plurality of treat gas feed lines to each of the plurality of reactors, each having a flow setpoint and under control of the programmable logic controller, which actuates the flow control valves in response to the calculated hydrogen consumption across each of the plurality of catalyst beds.

5. A method of controlling the hydrogen partial pressure in a hydroprocessing reactor having an oil feed and a treat gas feed, the method comprising the steps of:
providing a hydrogen analyzer for measuring the hydrogen purity of the treat gas supplied to the reactor, wherein the treat gas feed is composed of the mixture of a make-up hydrogen supply and recycled hydrogen from the reactor;
providing a pressure sensor for measuring the operating pressure of the reactor;
calculating the hydrogen partial pressure of the treat gas feed utilizing a programmable logic controller coupled to the pressure sensor and the hydrogen analyzer that receives the measurement of the hydrogen purity from the hydrogen analyzer and the measurement of the operating pressure of the reactor from the pressure sensor;
providing a purge control valve that diverts a portion of the recycle hydrogen from the treat gas feed, the purge control valve having a hydrogen partial pressure setpoint and under control of the programmable logic controller, which actuates the purge control valve in response to the deviation of the calculated hydrogen partial pressure from the hydrogen partial pressure setpoint.

6. The method of claim 5, wherein the reactor comprises a plurality of catalyst beds and a plurality of treat gas feed lines that supply treat gas to the inlet of each of the plurality of catalyst beds, and the method further comprises the steps of
providing an inlet temperature sensor and an outlet temperature sensor for measuring the temperature at the inlet and outlet of each of the plurality of catalyst beds, the temperature sensors coupled to the programmable logic controller, which calculates hydrogen consumption across each of the plurality of catalyst beds based upon the inlet and outlet temperature difference;
and providing flow control valves on each of the plurality of treat gas feed lines, each having a flow setpoint and under control of the programmable logic controller, which actuates the flow control valves in response to the calculated hydrogen consumption across each of the plurality of catalyst beds.

7. A method of controlling the hydrogen partial pressure in a plurality of hydroprocessing reactors, each having an oil feed and a treat gas feed, the method comprising the steps of:
providing a hydrogen analyzer for measuring the hydrogen purity of the treat gas supplied to each reactor, wherein the treat gas feed is composed of the mixture of a make-up hydrogen supply and recycled hydrogen from the reactor, and the treat gas feed from each reactor is routed to the hydrogen analyzer via a sample loop having a control valve;
providing a plurality of pressure sensors for measuring the operating pressure of each reactor;
providing a programmable logic controller to sequentially open and close the control valves on the sample loops from each reactor;
sequentially calculating the hydrogen partial pressure of the treat gas feed to each reactor utilizing the programmable logic controller, which is coupled to the pressure sensor and the hydrogen analyzer and receives the measurement of the hydrogen purity of the treat gas feed from each reactor from the hydrogen analyzer and the measurement of the operating pressures of each of the reactors from the plurality of pressure sensors;
providing a plurality of purge control valves that diverts a portion of the recycle hydrogen from the treat gas feed, the purge control valves having a hydrogen partial pressure setpoint and under control of the programmable logic controller, which sequentially actuates the purge control valves in response to the deviation of the calculated hydrogen partial pressure for each reactor from the hydrogen partial pressure setpoint of the respective purge control valve.
